(19) United States
(12) Patent Application Publication
(10) Pub. No.: US 2015/0198496 A1
(43) Pub. Date: Jul. 16, 2015

(54) PRESSURE TESTING WITH CONTROLLED APPLIED FLUID

(71) Applicant: Silicon Microstructures, Inc., Milpitas, CA (US)

(72) Inventor: Benny Zhu, San Jose, CA (US)

(73) Assignee: Silicon Microstructures, Inc., Milpitas, CA (US)

(21) Appl. No.: 14/156,266

(22) Filed: Jan. 15, 2014

(51) Int. Cl. G01L 27/00

(52) U.S. Cl. CPC G01L 27/00

(57) ABSTRACT

Circuits, methods, and apparatus for testing pressure sensors and other integrated circuits and devices while applying a well-controlled pressure are provided. A fluid may be received by a flow controller. The flow controller may provide the fluid to a first branch of a Y-shaped nozzle. The fluid may be directed at a device-under-test by a second branch of the Y-shaped nozzle. A resulting backpressure may be measured by a pressure sensor at a third branch of the Y-shaped nozzle. A height controller may vary a height of the Y-shaped nozzle relative to the device-under-test based on the measured backpressure. Once a target backpressure is reached, the pressure sensor die or other integrated circuit may be tested. The device-under-test may be tested at zero pressure, at one or more different pressures, or combination thereof.

### BACKGROUND

Pressure sensing devices have become ubiquitous the past few years as they have found their way into many types of products. Utilized in automotive, industrial, consumer, and medical products, the demand for pressure sensing devices has skyrocketed and shows no signs of abating.

Pressure sensing devices may include pressure sensors as well other components. Pressure sensors may typically include a diaphragm or membrane. When a pressure sensor in a pressure sensing device experiences a pressure, the membrane responds by changing shape. This change in shape causes one or more characteristics of electronic components on the membrane to change. These changing characteristics can be measured, and from this these measurements, the pressure can be determined.

Often, the electronic components are resistors that are configured as a Wheatstone bridge located on the membrane. As the membrane distorts due to pressure, the resistance of the resistors changes. This change results in an output of the Wheatstone bridge. This change can be measured through wires or leads attached to the resistors.

These pressure sensors are manufactured as die on wafers. The individual die may be tested during a process referred to as wafer-sort testing, where nonfunctional die may be marked with ink or otherwise identified. The functional or non-inked die may be assembled into packages and tested again at a final test, with the passing devices being shipped to customers.

It may be desirable to have the wafer-sort testing be thorough, that is, to identify as many nonfunctional die as possible. Each nonfunctional die that is not identified at wafer-sort testing may be packaged and tested unnecessarily a second time at final test. To avoid packaging and retesting nonfunctional devices, it may be desirable to test pressure sensor die at wafer-sort testing under an applied pressure. For increased reliability and consistency, it may be desirable that the applied pressure be well-controlled.

Thus, what is needed are circuits, methods, and apparatus that may apply a well-controlled pressure to a pressure sensor die or other integrated circuit die during wafer-sort testing.

### SUMMARY

Accordingly, embodiments of the present invention may provide circuits, methods, and apparatus that may apply a well-controlled pressure to a pressure sensor die or other integrated circuit die during wafer-sort testing. In an illustrative embodiment of the present invention, a flow of fluid may be directed towards a device-under-test by nozzle. A resulting backpressure in the nozzle may be measured and used to adjust one or more parameters until the resulting backpressure reaches a target value. The resulting backpressure may be equal to, or used as a proxy for, the pressure applied to the device-under-test. When the target backpressure is reached, the device-under-test may be tested.

In an illustrative embodiment of the present invention, a fluid may be received and provided by a flow controller. The flow controller may provide the fluid at a first flow rate to a first branch of a Y-shaped nozzle. The fluid may be directed at a device-under-test by a second branch of the Y-shaped nozzle. A resulting backpressure may be measured by a pressure sensor at a third branch of the Y-shaped nozzle. A height of an opening of the second branch of the Y-shaped nozzle relative to a device-under-test may be varied, for example, with a height or Z-controller, thus varying the resulting backpressure. When a targeted backpressure is reached, the pressure sensor may send a signal to the Z-controller, which may then substantially maintain the height of the nozzle over the device-under-test. Once the specific backpressure is reached, the pressure sensor die or other integrated circuit may be tested. These devices may be wafer-sort tested at zero pressure, one or more different pressures, or a combination of zero and one or more different pressures.

Embodiments of the present invention may provide various feedback techniques for controlling the pressure at a device-under-test. In various embodiments of the present invention, a resulting backpressure may be measured using a pressure sensor or other appropriate device. In one embodiment of the present invention, a nozzle may be lowered (or raised) until a specific or target backpressure is reached. From there, the nozzle may be held in place to substantially maintain the flow rate of the fluid. For example, a mechanism, such as the above Z-controller, may continue to monitor the backpressure signal from the pressure sensor and lower the nozzle (or raise the wafer) when the measured backpressure drops below the specific backpressure and raise the nozzle (or lower the wafer) when the backpressure exceeds the specific backpressure. Once the specific backpressure is reached, the pressure sensor die or other integrated circuit may be tested.

In other embodiments of the present invention, a range of backpressure may be targeted instead of a specific value. For example, the nozzle may be lowered (or wafer raised) until a range of targeted backpressure is reached. From there, the nozzle may substantially maintain its position. For example, a mechanism may monitor the backpressure signal and lower the nozzle (or raise the wafer) when the measured backpressure drops below the targeted range of backpressure, raise the nozzle (or lower the wafer) when the measured backpressure exceeds the range of targeted backpressure, and maintain the position of the nozzle when the measured backpressure is in the range of targeted backpressure. Once the targeted range backpressure is reached, the pressure sensor die or other integrated circuit may be tested.

In other embodiments of the present invention, the nozzle may be lowered until a target backpressure is reached. Once the target is reached, the position of the nozzle may simply be maintained and the device may be tested.

In other illustrative embodiments of the present invention, other parameters may be varied with, or instead of, relative nozzle height to provide a well-controlled pressure. For example, in a specific embodiment of the present invention, a flow rate of a fluid may be varied until a desired backpressure is measured.

Again, a pressure sensor may provide a signal indicating the measured backpressure to the flow controller. The flow controller may increase (or decrease) the flow rate of the fluid until a specific backpressure is reached. From there, the flow controller may substantially maintain the flow rate of the fluid. For example, the flow controller may continue to monitor the backpressure signal and increase the flow rate when the measured backpressure drops below the specific backpressure and decrease the flow rate when the backpressure exceeds the specific backpressure. Once the specific backpressure is reached, the pressure sensor die or other integrated circuit may be tested.

In other embodiments of the present invention, a range of backpressure may be targeted instead of a specific value. For example, the flow controller may increase the flow rate of the fluid until a range of targeted backpressure is reached. From there, the flow controller may substantially maintain the flow rate of the fluid. For example, the flow controller may continue to monitor the backpressure signal and increase the flow rate when the measured backpressure drops below the targeted range of backpressure, decrease the flow rate when the measured backpressure exceeds the range of targeted backpressure, and maintain the flow rate when the measured backpressure is in the range of targeted backpressure. Once the targeted range backpressure is reached, the pressure sensor die or other integrated circuit may be tested.

In other embodiments of the present invention, the flow controller may increase the flow rate until a target backpressure is reached. Once the target is reached, the flow controller may simply maintain the present flow rate and the device may be tested.

In still other embodiments of the present invention, a width of the opening of the nozzle may be varied. For example, the nozzle may be narrowed (or widened) until a specific backpressure is reached. From there, the nozzle width may be maintained to substantially maintain the flow rate of the fluid. A mechanism may continue to monitor the backpressure signal and narrow the opening of the nozzle when the measured backpressure drops below the specific backpressure and widen the opening of the nozzle when the backpressure exceeds the specific backpressure. Once the specific backpressure is reached, the pressure sensor die or other integrated circuit may be tested.

Again, in other embodiments of the present invention, a range of backpressure may be targeted instead of a specific value. For example, the nozzle may be widened or narrowed until a range of targeted backpressure is reached. From there, the nozzle may substantially maintain its width. For example, a mechanism may monitor the backpressure signal and widen the nozzle when the measured backpressure drops below the targeted range of backpressure, narrow the nozzle when the measured backpressure exceeds the range of targeted backpressure, and maintain the width of the nozzle when the measured backpressure is in the range of targeted backpressure. Once the targeted range backpressure is reached, the pressure sensor die or other integrated circuit may be tested.

In other embodiments of the present invention, the nozzle may be widened or narrowed until a target backpressure is reached. Once the target is reached, the width of the nozzle may simply be maintained and the device may be tested.

Again, in the above embodiments of the present invention, a known pressure is applied to a device-under-test while the device is being tested. This allows for electrical wafer-testing of pressure sensor devices at actual pressure. Test results, such as resistance measurements at a pressure, can be used by themselves, or with test results at zero or other pressures to determine whether a device is functional, and in some circumstances could be used to determine a grade or binning of a device.

In other embodiments of the present invention, instead of testing a device at a fixed pressure, the pressure may be varied during a test. The pressure may be varied by changing a height of a nozzle, a fluid flow rate, or a width of a nozzle opening. In still other embodiments of the present invention, instead of only performing electrical tests on a device-under-test, mechanical-oriented tests may also be performed. That is, mechanical tests, such as tests to determine a mechanical or physical deflection of the membrane, may also be performed.

In these and other embodiments of the present invention, the height, flow rate, or nozzle width may be initially calibrated before being used to apply pressure to a pressure sensor membrane. For example, a nozzle may be positioned above a die, wafer, or other structure that is less susceptible to deflection than a membrane. The nozzle may be positioned above a test structure, a portion of a frame, or other similar inflexible region. Fluid may be directed toward the test structure or frame. The nozzle height, flow rate, or nozzle width may be varied as described above until a target backpressure is reached.

The nozzle may then be moved over the membrane on the device-under-test and the same nozzle height, flow rate, and nozzle width may be used while fluid is directed at the membrane. A change in pressure may be measured. In various embodiments of the present invention, this change in pressure may be measured and used to determine a deflection of the membrane or other appropriate parameter.

In other embodiments of the present invention, the change in pressure may be measured and the nozzle may be lowered, fluid rate increased, or nozzle opening narrowed until the target backpressure is reached again. This change in height, fluid rate, or nozzle opening may be used to determine a deflection of the membrane or other appropriate parameter. It should be noted that these mechanical-oriented tests may be performed on a device-under-test in the absence of any wafer-probe or other electrical testing.

Also, other types of mechanical tests, such as burst tests may be performed using embodiments of the present invention. For example, a fluid pressure may be increased until a membrane reaches a point of mechanical failure. A measured pressure at the point of failure could be used to evaluate membrane thickness, wafer integrity, or other parameters.

In various embodiments of the present invention, different fluids may be provided by the flow controller. For example, air or an inert gas may be provided by the flow controller. In various embodiments of the present invention, nitrogen, argon, or other gas or fluid may be provided by the flow controller. In various embodiments of the present invention, the fluid may be heated or cooled to change a temperature of a device-under test, or portion thereof, during testing. It should also be noted that the passage of fluid across a membrane may have a cooling effect on a device-under test.

Various embodiments of the present invention may test wafers using the above techniques in different ways. For example, each die may be individually tested. That is, a flow rate, nozzle height, or nozzle width may be varied for each die. In other embodiments of the present invention, the results of testing one die may be used in testing one or more other die. For example, once a flow rate corresponding to a specific backpressure is known, this flow rate may be set by the flow controller and used in testing one or more following wafers. In this case, the flow controller may simply set the flow rate while testing the later die and not adjust the flow rate based on the measured backpressure. In other embodiments, the flow controller may use a flow rate corresponding to a specific backpressure measured on a first die and use that as a starting flow rate on later die, while using the measured backpressure to adjust the flow rate. These and other techniques may include the other types of feedback and parameter adjustments described herein.

Various embodiments of the present invention may incorporate one or more of these and the other features described herein. A better understanding of the nature and advantages of the present invention may be gained by reference to the following detailed description and the accompanying drawings.

### BRIEF DESCRIPTION OF THE DRAWINGS

FIG. 1 illustrates a wafer-sort system according to an embodiment of the present invention;

FIG. 2 illustrates a wafer-sort testing apparatus where a relative height of a nozzle over a surface of a wafer may be varied to control an applied pressure;

FIG. 3 illustrates a wafer-sort system where a flow of fluid in a nozzle may be varied to control and applied pressure;

FIG. 4 illustrates a wafer-sort system where a pressure applied to a device-under-test is varied by varying a width of a nozzle;

FIG. 5 illustrates a method of adjusting a pressure applied to a device-under-test according to an embodiment of the present invention;

FIG. 6 illustrates a measured backpressure over time, where the backpressure is adjusted according to an embodiment of the present invention;

FIG. 7 illustrates a method of adjusting a pressure applied to a device-under-test according to an embodiment of the present invention;

FIG. 8 illustrates a measured backpressure over time, where the backpressure is adjusted according to an embodiment of the present invention;

FIG. 9 illustrates a method of adjusting a pressure applied to a device-under-test according to an embodiment of the present invention;

FIG. 10 illustrates a measured backpressure over time, where the backpressure is adjusted according to an embodiment of the present invention; and

FIG. 11 illustrates a method of testing multiple die on a wafer according to an embodiment of the present invention.

### DESCRIPTION OF ILLUSTRATIVE EMBODIMENTS

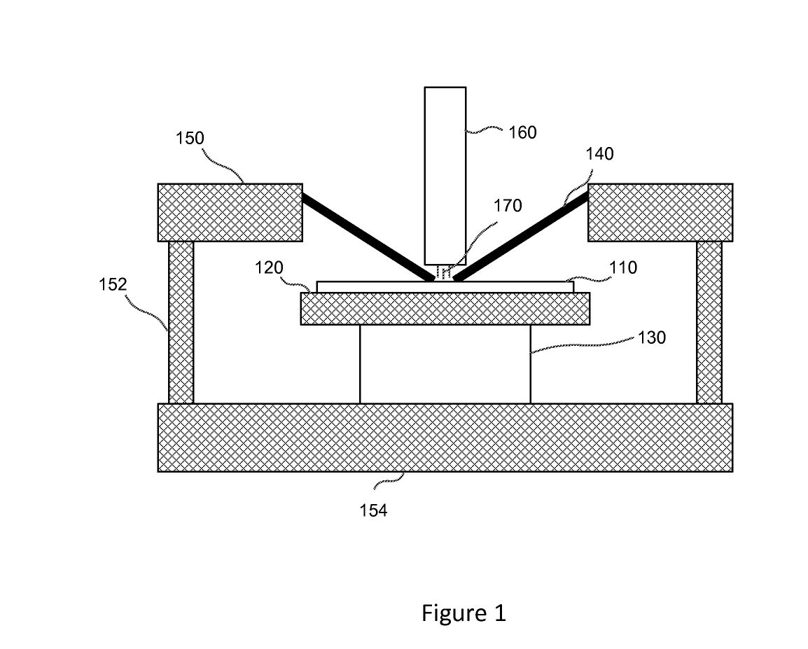

FIG. 1 illustrates a wafer-sort system according to an embodiment of the present invention. This figure, as with the other included figures, is shown for illustrative purposes and does not limit either the possible embodiments of the present invention or the claims.

Wafer 110 may be placed on a surface of holder 120. During testing, holder 120 may be moved by chuck 130. Chuck 130 may also provide a suction or vacuum force to keep wafer 110 in place on holder 120. Probe card 150 may support one or more probes 140. Probes 140 may make contact with pads (not shown) on individual die on wafer 110. Probes 140 may provide input voltages or currents and measure output voltages or currents at these pads. Probe card 150 may be supported by a frame 152 residing on a support structure 154.

Again, it is desirable to identify as many improperly functioning die on wafer 110 as possible during this wafer-sort testing. An improperly functioning die missed at this stage results in that improperly functioning die being packaged and tested again at final test. Identifying such an improperly functioning die at wafer-sort reduces total packaging costs and improves final test yield.

Pressure sensors may be tested at a zero pressure state. Such testing may be sufficient to identify a good number of improperly functioning die at wafer-sort. To improve wafer-sort testing, and therefore to reduce packaging costs and improve final test yields, embodiments of the present invention may provide methods, circuits, and apparatus for additionally testing pressure sensors while they are under pressure. That is, embodiments of the present invention may enable the testing of die on a wafer at one or more different pressures. These tests may include electrical tests, such as resistance measurements, and mechanical tests, such as membrane deflection measurements.

Accordingly, the apparatus in this figure may include nozzle 160 to provide a flow 170 of fluid to a surface of a die on wafer 110. This fluid may be directed to a membrane on a pressure sensor or other structure. Flow 170 may provide a pressure at the membrane of the pressure sensor. In other embodiments of the present invention, nozzle 160 may provide a vacuum, which may provide a negative pressure at the membrane of the pressure sensor die being tested.

The resulting pressure, negative or positive, may deform the membrane, which may result in a pressure reading from the pressure sensor die on wafer 110. The pressure sensor reading from the device-under-test may be read using one or more probes 140. The results of these measurements may be used to identify a properly functioning or an improperly functioning die on wafer 110.

By providing a flow 170, nozzle 160 does not need to come into contact with wafer 110, thereby protecting both wafer 110 and nozzle 160.

In a specific embodiment of the present invention, a pressure sensor die being tested may include a Wheatstone bridge, multiple active devices, or other structures. An input voltage may be applied to the Wheatstone bridge or other structure using one or more probes 140. A resulting output voltage from the Wheatstone bridge or other structure may be read using one or more probes 140. These voltages may be measured with zero or one or more positive or negative pressures applied to the membrane of the device-under-test. For example, a die may be tested at zero pressure and one or more positive pressures.

It should be noted that, while embodiments of the present invention are particularly well suited for testing pressure sensors, other devices, such as flow rate sensors, touch screens, touch switches, and other types of devices may be tested, using embodiments of the present invention.

For example, a flow rate sensor may include a die with two resistors, one on each side of a wire. Current may be passed through the wire, generating heat. This heat may change the value of the neighboring resistors. As air or another fluid passes across the surface of the flow rate sensor, a value of one resistor may change relative to the other. The difference in values of the resistors may provide an indication of the rate of flow of the fluid. The air or other fluid may be applied, using techniques according to embodiments of the present invention.

To improve the repeatability and usefulness of this pressure testing, embodiments of the present invention may provide methods, circuits, and apparatus for providing a well-controlled pressure. By providing a well-controlled pressure, testing accuracy and repeatability may be improved. Embodiments of the present invention may provide a well-controlled pressure by providing a fluid flow 170 at an output of nozzle 160, measuring a resulting backpressure, and then using the measured backpressure to adjust fluid flow 170. Fluid flow 170 may be varied by changing a height of nozzle 160 relative to wafer 110, by varying a flow rate through nozzle 160, by varying a width of an opening or other portion of nozzle 160, or by varying other appropriate parameters. Examples of this are shown in the following figures.

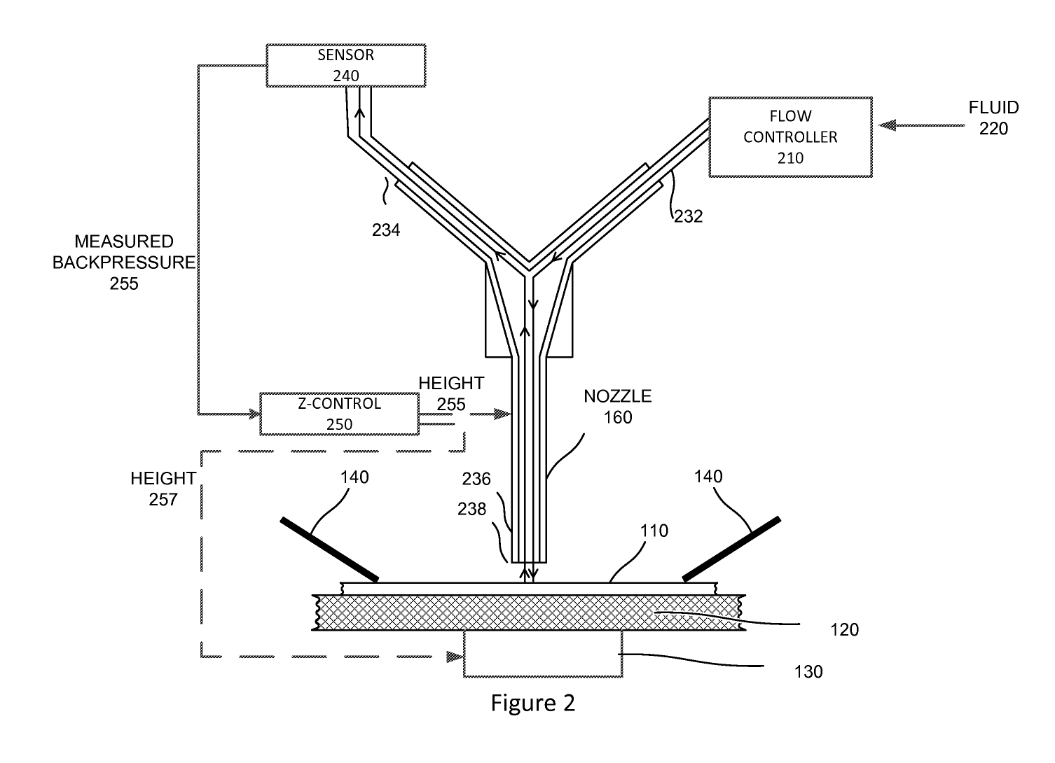

FIG. 2 illustrates a wafer-sort testing apparatus where a height of a nozzle relative to a surface of a wafer may be varied to control a pressure applied to a device-under-test. In this example, flow controller 210 may receive the fluid 220. Flow controller 210 may provide the fluid to a first branch 232 of nozzle 160. A second branch 236 of nozzle 160 may provide this fluid through opening 238 to a surface of a die on wafer 110. As before, wafer 110 may reside on holder 120, which may be positioned by chuck 130. Probes 140 may be used to provide input and measure output voltages and currents on the die being tested.

Sensor 240 may be connected to a third branch 234 of nozzle 160. Sensor 240 may sense a backpressure in nozzle 160. The backpressure of nozzle 160 may be the same or related to a pressure being experienced by the device-under-test. Sensor 240 may use this backpressure measurement to control a height of nozzle 160 relative to wafer 110. Specifically, Z-controller 250 may control the height by moving nozzle 160. In other embodiments of the present invention, Z-controller 250 may adjust this height by moving the position of chuck 130.

Specifically, sensor 240 may provide a measured backpressure signal 255 to a height control unit or Z-controller 250. Z-controller 250 may provide a height signal 255 to adjust the vertical position of nozzle 160. Alternately, Z-controller 250 may provide a height signal 257 to control a height or Z-position of wafer 110 by moving chuck 130 up or down. In various embodiments of the present invention, care should be taken that changing the height of wafer 110 does not cause probes 140 to form unreliable connections with pads on the device-under-test or that probes 140 do not damage the device-under-test or adjoining structures. In this example, as the relative height of nozzle 160 relative to wafer 110 increases, the measured backpressure, and hence the applied pressure at the device-under-test, may decrease, while a decrease in height may increase the backpressure and applied pressure.

Again, these techniques may be used to measure electrical properties of a device-under-test at a pressure. Similar techniques may also be used to measure physical or mechanical properties of the device-under-test. For example, the amount of deflection of a membrane may be estimated or determined.

In a specific embodiment of the present invention, the height of a nozzle may be initially calibrated. For example, a nozzle may be positioned above a die, wafer, or other structure that is less susceptible to deflection than a membrane, such as a test structure, a portion of a frame, or other similar inflexible region. Fluid may be directed toward the test structure or frame. The height of the nozzle may be varied as described above until a target backpressure is reached.

The nozzle may then be moved over the membrane on the device-under-test and the same nozzle height may be used while fluid is directed at the membrane. A change in pressure may be measured. In various embodiments of the present invention, this change in pressure may be measured and used to determine a deflection of the membrane or other appropriate parameter.

In other embodiments of the present invention, the change in pressure may be measured and the nozzle may be lowered until the target backpressure is reached again. This change in height may be used to determine a deflection of the membrane or other appropriate parameter.

Also, other types of mechanical tests, such as burst tests may be performed using embodiments of the present invention. For example, a fluid pressure may be increased until a membrane reaches a point of mechanical failure. A measured pressure at the point of failure could be used to evaluate membrane thickness, wafer integrity, or other parameters.

In various embodiments of the present invention, fluid 220 may be air, argon, nitrogen, or other inert or non-inert gas. In various embodiments of the present invention, the fluid may be heated or cooled to change a temperature of a membrane during testing. It should also be noted that the passage of fluid across a membrane may have a cooling effect on a device-under test.

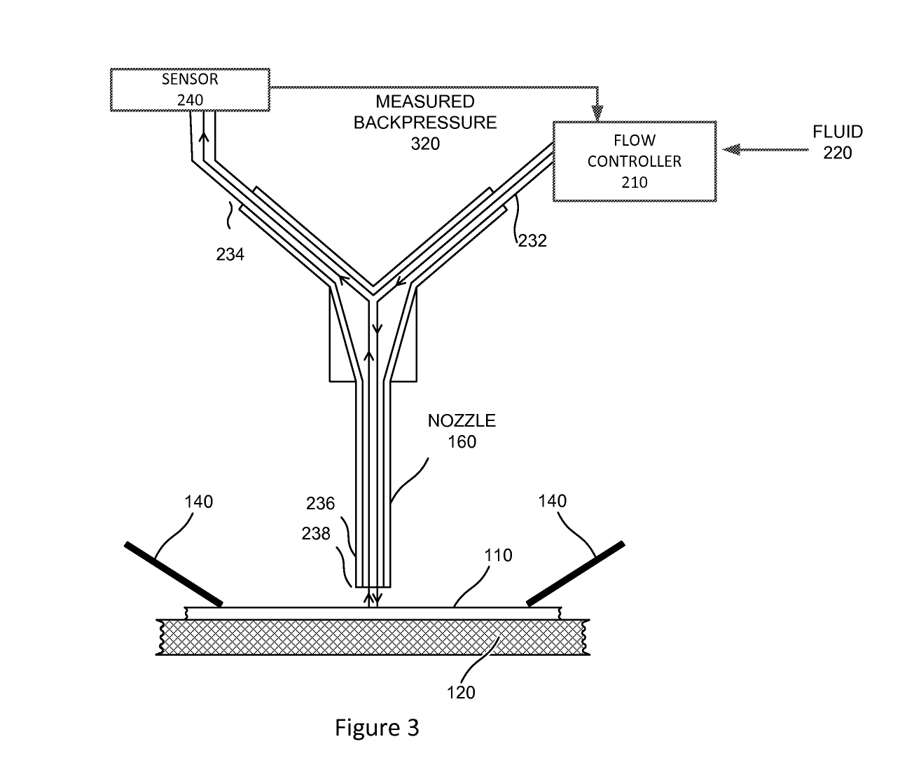

FIG. 3 illustrates a wafer-sort system where a flow of fluid in nozzle 160 may be varied to control an applied pressure. Again, wafer 110 may be tested using probes 140 while it resides on holder 120. Flow controller 210 may provide a fluid to a first branch 232 of nozzle 160. Nozzle 160 may provide the fluid 220 through opening 238 in a second branch to a die on wafer 110. Sensor 240 on a third branch 234 of nozzle 160 may measure a resulting backpressure as before. The measured backpressure signal 320 may be received by flow controller 210. Flow controller 210 may increase or decrease the flow as needed to provide a desired backpressure at sensor 240. Specifically, flow controller 210 may increase flow of fluid 220 to increase backpressure, and hence the pressure applied to the device-under-test. Flow controller 210 may decrease the flow of fluid 220 to decrease the backpressure and applied pressure. The backpressure measured by backpressure sensor 240 may be the same as, or related to, the pressure experienced by a device-under-test on wafer 110.

Again, similar techniques may be used to measure physical or mechanical properties of the device-under-test. In a specific embodiment of the present invention, the fluid flow rate may be initially calibrated. For example, a nozzle may be positioned above a die, wafer, or other structure that is less susceptible to deflection than a membrane, such as a test structure, a portion of a frame, or other similar inflexible region. Fluid may be directed toward the test structure or frame. The flow rate of fluid in the nozzle may be varied as described above until a target backpressure is reached.

The nozzle may then be moved over the membrane on the device-under-test and the same nozzle height may be used while fluid is directed at the membrane. A change in pressure may be measured. In various embodiments of the present invention, this change in pressure may be measured and used to determine a deflection of the membrane or other appropriate parameter.

In other embodiments of the present invention, the change in pressure may be measured and the flow rate may be increased until the target backpressure is reached again. This change in flow rate may be used to determine a deflection of the membrane or other appropriate parameter.

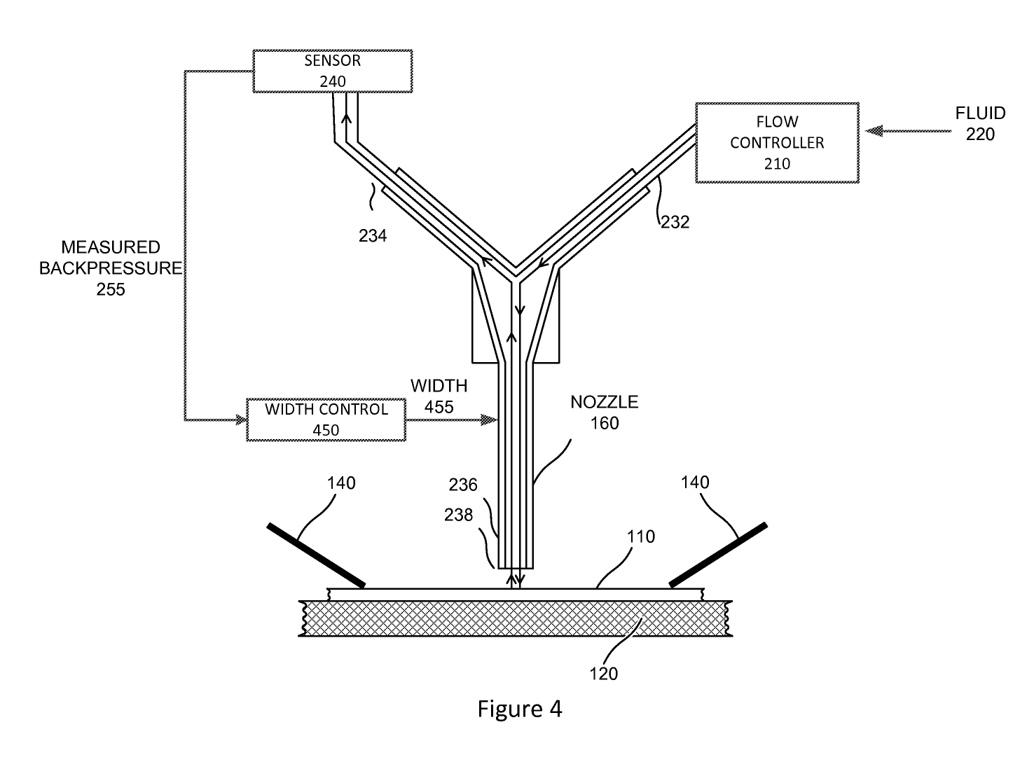

FIG. 4 illustrates a wafer-sort system where a pressure applied to a device-under-test is varied by varying a width of an opening or other portion of a nozzle. As before, a die on wafer 110 may be tested using probes 140. Wafer 110 may reside on holder 120.

Flow controller 210 may provide fluid 220 to a first branch 232 of nozzle 160. Nozzle 160 may provide this fluid through opening 238 of a second branch 236 to the device-under-test. A resulting backpressure may be read by sensor 240, which may be attached to nozzle 160 through third branch 234. Sensor 240 may provide a measured backpressure signal 255 to width control circuits 450. Width control circuit 450 may provide a width signal 455 to nozzle 160. Nozzle 160 may open or constrict as a result of this signal. For example, an opening 238 may open or constrict under control of signal 455. Specifically, if the measured backpressure 255 is below a desired level, the width signal may instruct opening 238 to constrict, thereby increasing the measured backpressure at sensor 240. If the measured backpressure 255 is above a desired level, the width signal may instruct opening 238 to widen, thereby decreasing the measured backpressure at sensor 240. As before, the backpressure measured by sensor 240 may be the same as, or a proxy for, the pressure applied to the device-under-test.

Again, similar techniques may be used to measure physical or mechanical properties of the device-under-test. In a specific embodiment of the present invention, the nozzle opening width may undergo an initial calibration. For example, a nozzle may be positioned above a die, wafer, or other structure that is less susceptible to deflection than a membrane, such as a test structure, a portion of a frame, or other similar inflexible region. Fluid may be directed toward the test structure or frame. The opening in the nozzle may be varied as described above until a target backpressure is reached.

The nozzle may then be moved over the membrane on the device-under-test and the same nozzle height may be used while fluid is directed at the membrane. A change in pressure may be measured. In various embodiments of the present invention, this change in pressure may be measured and used to determine a deflection of the membrane or other appropriate parameter.

In other embodiments of the present invention, the change in pressure may be measured and the nozzle opening may be narrowed until the target backpressure is reached again. This change in nozzle opening may be used to determine a deflection of the membrane or other appropriate parameter.

In various embodiments of the present invention, a backpressure measured by sensor 240 may be used to adjust the pressure received by the die in various ways. For example, a feedback loop may adjust a parameter to increase the pressure when the measured backpressure is too low. When the measured backpressure is too high, the loop may adjust a parameter to decrease the pressure. In other embodiments of the present invention, a targeted range of pressures may be used. If a measured backpressure is below the targeted range, a parameter may be varied to increase the pressure, while, if a measured backpressure is above the targeted range, a parameter may be varied to decrease the measured backpressure. When a measured pressure is in the targeted range, no adjustment is made. In still other embodiments of the present invention, a pressure may be increasingly or decreasingly ramped until a desired backpressure is reached. At that time, no further changes to the parameter are made. These and other types of feedback configurations may be employed by embodiments of the present invention. Examples are shown in the following figures.

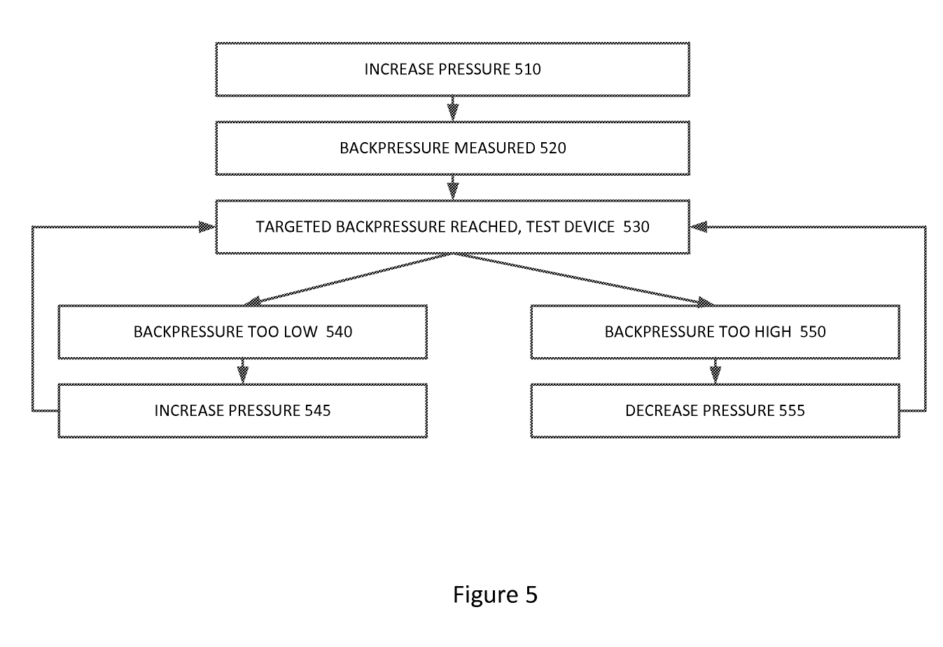

FIG. 5 illustrates a method of adjusting a pressure at a device-under-test according to an embodiment of the present invention. In this and the other included examples, it is assumed that the pressure is initially zero or at a low value and is increased. In other embodiments the present invention, the initial pressure may be high and the initial feedback may be to decrease the pressure. It should be noted that this may be somewhat undesirable as excess pressure may damage a device-under-test.

Accordingly, in act 510, a pressure is increased, while a resulting backpressure is measured in act 520. In act 530, a targeted backpressure is reached. At this time, the device may be tested. If a backpressure falls low, as in act 540, the pressure may be increased in act 545. Similarly, when the backpressure becomes excessive in act 550, the backpressure pressure may be decreased in act 555.

The pressure may be increased in the above example by decreasing a height of nozzle 160 relative to wafer 110 (by either lowering nozzle 160 or raising wafer 110, or both), by increasing a flow rate of fluid 210 in nozzle 160, or by constricting opening 238 on nozzle 160. The pressure may be decreased in the above examples by increasing a height of nozzle 160 relative to wafer 110 (by either raising nozzle 160 or lowering wafer 110, or both), by decreasing a flow rate of fluid 210 in nozzle 160, or by widening opening 238 of nozzle 160.

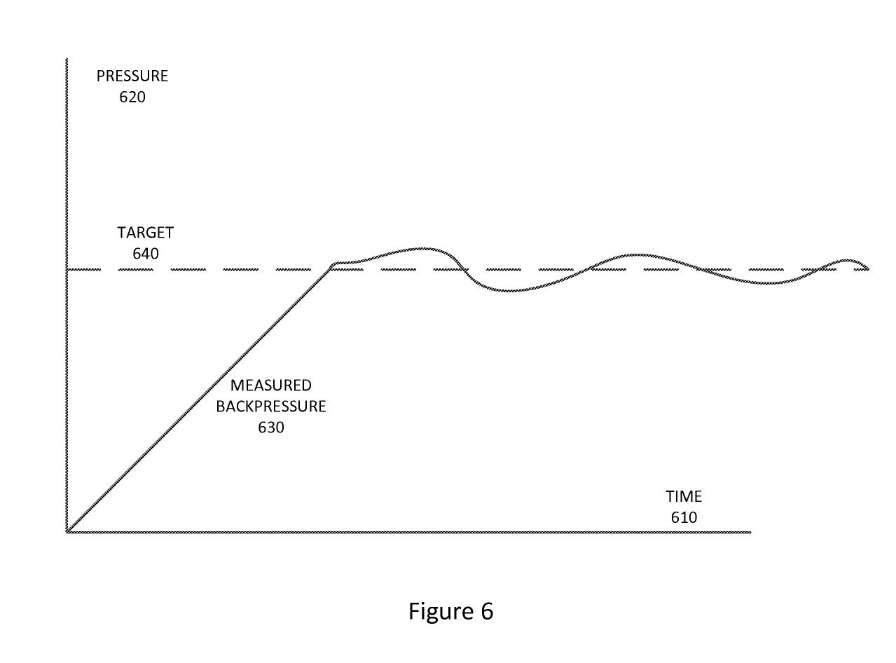

FIG. 6 illustrates a measured backpressure over time 610, where the backpressure is adjusted according to an embodiment of the present invention. This curve may be the result of using the feedback technique outlined in the above figure. Initially, pressure 620 may be increased, leading to an increase in measured backpressure 630. Once the target 640 is reached, the measured backpressure may slightly oscillate above and below target 640 while the feedback loop attempts to match the measured backpressure 630 to target 640.

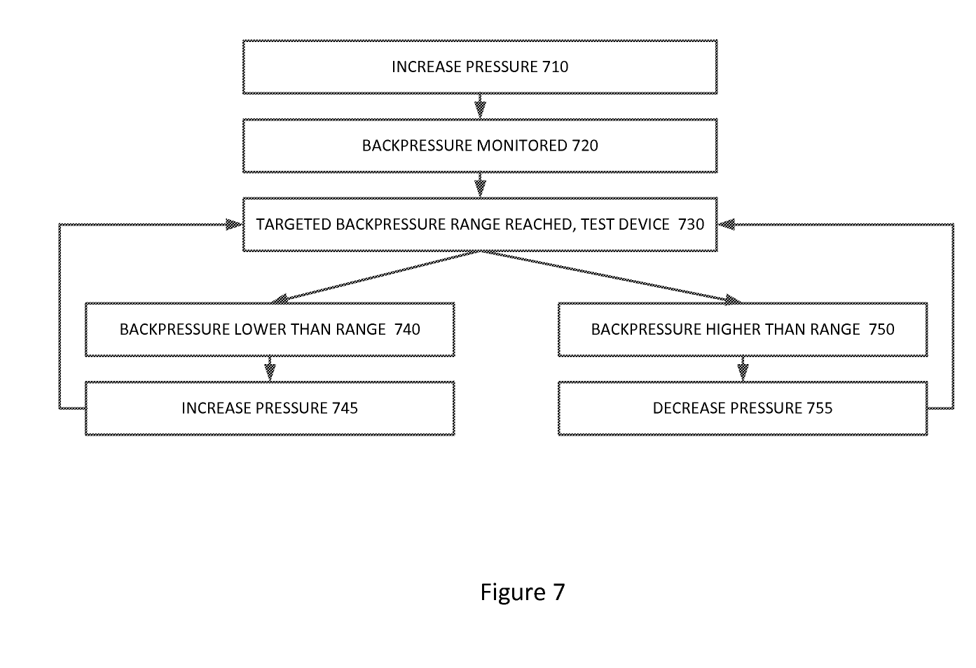

FIG. 7 illustrates a method of adjusting a pressure applied to a device-under-test according to an embodiment of the present invention. Again, it is assumed that the pressure is initially zero or low and is increased above that level. Again, in act 710, a pressure may be increased, while in act 720, a backpressure may be measured. In act 730, a targeted backpressure range is reached, and the device may be tested. When the backpressure becomes lower than the range, as in act 740, the pressure may be increased in act 745. When the backpressure is higher than the range in act 750, the pressure may be decreased in act 755.

Again, the pressure may be increased in the above example by decreasing a height of nozzle 160 relative to wafer 110 (by either lowering nozzle 160 or raising wafer 110, or both), by increasing a flow rate of fluid 210 in nozzle 160, or by constricting opening 238 on nozzle 160. The pressure may be decreased in the above examples by increasing a height of nozzle 160 relative to wafer 110 (by either raising nozzle 160 or lowering wafer 110, or both), by decreasing a flow rate of fluid 210 in nozzle 160, or by widening opening 238 of nozzle 160.

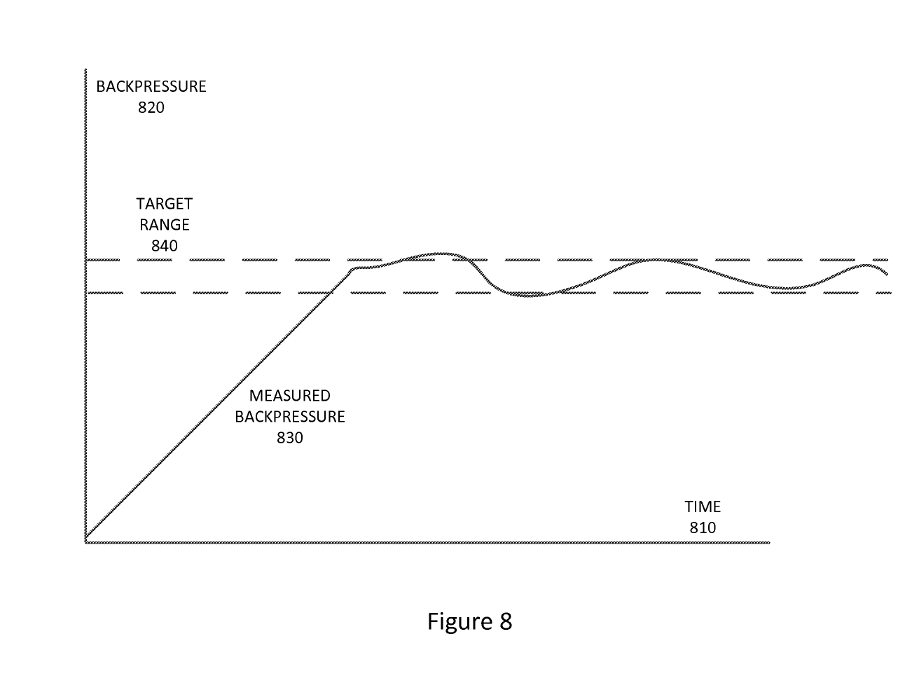

FIG. 8 illustrates a measured backpressure over time, where the backpressure 820 is adjusted according to an embodiment of the present invention. Again, measured backpressure 830 may be initially zero or at a low value and increased until target range 840 is reached. At this time, as a measured backpressure 830 increases above target range 840, the backpressure may be decreased, while when measured backpressure 830 drops below range 840, backpressure 830 may be increased.

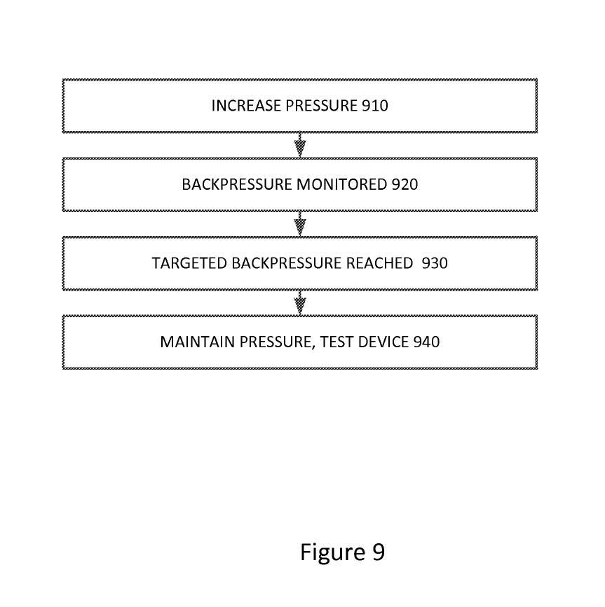

FIG. 9 illustrates a method of adjusting a pressure applied to a device-under-test according to an embodiment of the present invention. Once again, in act 910, a pressure may be increased, while in 920, a backpressure may be monitored. When a targeted backpressure is reached in act 930, the pressure may be maintained in act 940 and the device may be device-tested.

Again, the pressure may be increased in the above example by decreasing a height of nozzle 160 relative to wafer 110 (by either lowering nozzle 160 or raising wafer 110, or both), by increasing a flow rate of fluid 210 in nozzle 160, or by constricting opening 238 on nozzle 160. The pressure may be decreased in the above examples by increasing a height of nozzle 160 relative to wafer 110 (by either raising nozzle 160 or lowering wafer 110, or both), by decreasing a flow rate of fluid 210 in nozzle 160, or by widening opening 238 of nozzle 160.

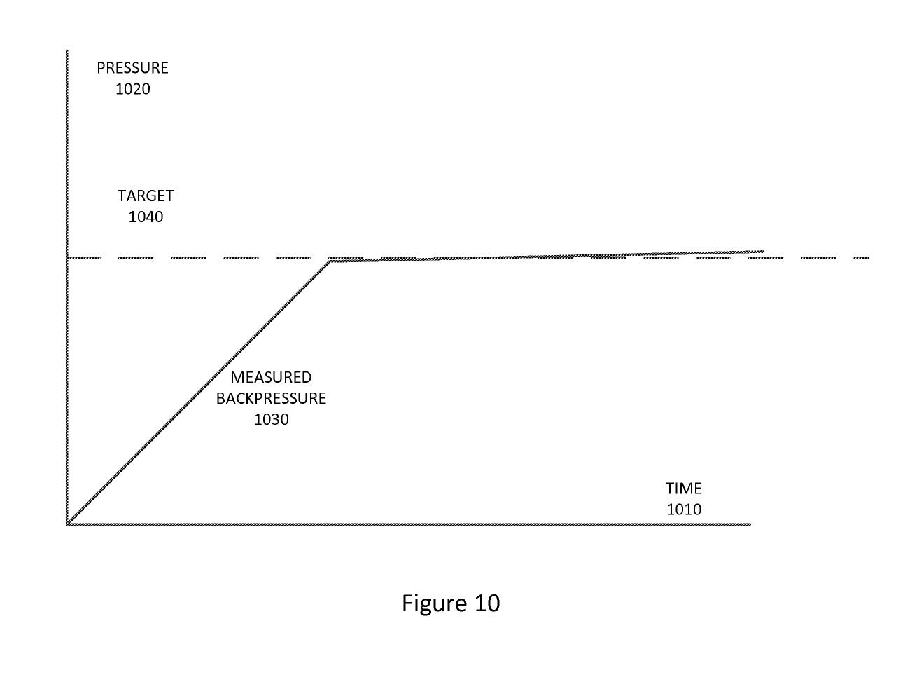

FIG. 10 illustrates a measured backpressure over time 1010, where the backpressure is adjusted according to an embodiment of the present invention. Again, measured backpressure 1030 may be initially zero or at a low value, and increased until a target value 1040 is reached. Once target value 1040 is reached, that pressure may be maintained. In this embodiment, a small amount of drift may cause the measured backpressure to either increase or decrease with time 1010.

In various embodiments of the present invention, each of the die on wafer 110 may be tested according to one of the methods outlined above. In other embodiments the present invention, one or more parameters, such as a height setting, flow rate, or nozzle width, may be stored and used in testing one or more subsequent die. An advantage of this may be to reduce overall test time. A disadvantage may be that one or more of these parameters may not be accurate for an adjacent die and may lead to either incorrectly identifying functional die as non-functional or nonfunctional die as functional. An example is shown in the following figure.

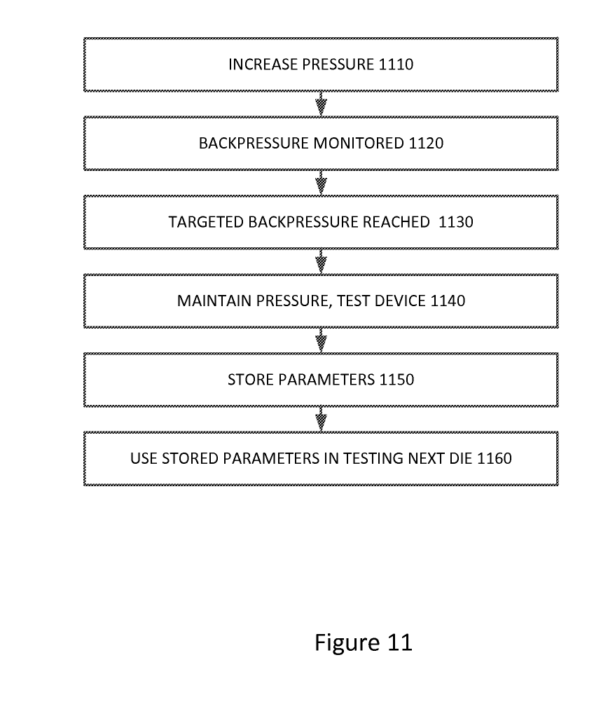

FIG. 11 illustrates a method of testing multiple die on wafer according to an embodiment of the present invention. In act 1110, a pressure is increased, while in act 1120, a resulting backpressure is measured. Once a targeted backpressure is reached in act 1130, pressure may be maintained and the device tested in act 1140. This pressure may be maintained in any of the above outlined or other methods. In act 1150, one or more parameters are stored. These parameters may include a height of nozzle 160 relative to wafer 110 (for example, a Z-position of nozzle 160 or chuck 130), a flow rate of fluid 220 through flow controller 210, a width of an opening 238 on nozzle 160, or other appropriate parameter or parameters. In act 1160, the stored primaries may be used in testing a next die. Parameters may be recalculated on a periodic basis. For example, they may be really calculated every wafer, every line of dies across a wafer, or once for some number of die.

In other embodiments of the present invention, pressure testing may be performed on a limited number of die on the wafer. For example, only one die in N may be tested, where N is 2, 5, 10, or other number. This may help to reduce wafer-sort test times.

In various embodiments of the present invention, more than one of the above methods may be employed in testing a wafer. For example, a position of nozzle 160 may be controlled until an initial pressure is achieved. From there, the flow rate may be varied and testing may be done at different pressures.

In various embodiments of the present invention, various types of tests may be performed. For example, it may be desirable to perform a destructive test where pressure is increased until a mechanical failure of a membrane or other portion of a device-under-test occurs. In various embodiments of the present invention, these destructive tests are done on devices that have been previously identified as non-functional.

The above description of embodiments of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated. Thus, it will be appreciated that the invention is intended to cover all modifications and equivalents within the scope of the following claims.

What is claimed is:

1. A method of testing a pressure sensor die, the method comprising:
directing a flow of a fluid at a surface of the pressure sensor die, where the fluid is provided by a nozzle;
measuring a resulting backpressure in the nozzle;
adjusting a height of the nozzle relative the surface of the pressure sensor die based on the measured resulting backpressure;
applying a first input to a first pad on the pressure sensor die; and
measuring a first output at a second pad on the pressure sensor die.

2. The method of claim 1 wherein the fluid is air.

3. The method of claim 1 wherein the fluid is an inert gas.

4. The method of claim 1 wherein a temperature of the fluid is changed before the fluid is directed at a surface of the pressure sensor die.

5. The method of claim 1 wherein the flow of the fluid is directed at a surface of a membrane on the pressure sensor die.

6. The method of claim 5 wherein the resulting backpressure is measured with a pressure sensor device.

7. The method of claim 6 wherein the flow of the fluid is directed using a Y-shaped nozzle, wherein the fluid is received at a first branch of the Y, the resulting backpressure is measured at a second branch of the Y, and the fluid is directed using a third branch of the Y.

8. The method of claim 7 wherein the height of the nozzle relative the surface of the pressure sensor die is adjusted by decreasing the height until a specified backpressure is measured, then at least substantially maintaining the rate.

9. The method of claim 8 wherein applying a first input to a first pad on the pressure sensor die comprises applying an input voltage to a Wheatstone bridge.

10. The method of claim 9 wherein measuring a first output at a second pad on the pressure sensor die comprises measuring an output voltage of a Wheatstone bridge.

11. A method of testing an integrated circuit, the method comprising:
increasing a flow of a fluid at a surface of the integrated circuit;
measuring a resulting backpressure and when a specified backpressure is measured;
substantially maintaining the flow rate of the flow of the fluid at the surface of the pressure sensor die;
applying a first input to a first pad on the pressure sensor die; and
measuring a first output at a second pad on the pressure sensor die.

12. The method of claim 11 wherein the integrated circuit comprises a pressure sensor die and the flow of the fluid is directed at a surface of a membrane on the pressure sensor die.

13. The method of claim 11 wherein the integrated circuit comprises a flow-rate controller.

14. The method of claim 11 wherein the fluid is air.

15. The method of claim 11 wherein the fluid is an inert gas.

16. The method of claim 11 wherein the resulting backpressure is measured with a pressure sensor device.

17. The method of claim 16 wherein the flow of the fluid is directed using a Y-shaped nozzle, wherein the fluid is received at a first branch of the Y, the resulting backpressure is measured at a second branch of the Y, and the fluid is directed using a third branch of the Y.

18. The method of claim 17 wherein applying a first input to a first pad on the pressure sensor die comprises applying an input voltage to a Wheatstone bridge and measuring a first output at a second pad on the pressure sensor die comprises measuring an output voltage of a Wheatstone bridge.

19. An apparatus for testing a pressure sensor die comprising:
a flow controller to receive a fluid and to provide the fluid at a flow rate;
a pressure sensor to measure a backpressure and to provide a signal based on the measured backpressure;
a Y-shaped nozzle; and
a controller to adjust a height of the Y-shaped nozzle relative to the pressure, where the height is adjusted using the signal based on the measured backpressure,
wherein the fluid is received from the flow controller at a first branch of the Y-shaped nozzle, the resulting backpressure is measured at a second branch of the Y-shaped nozzle, and the fluid is directed towards a pressure sensor die using a third branch of the Y-shaped nozzle.

20. The apparatus of claim 19 further comprising a probe card supporting a number of probes for contacting pads on the pressure sensor die.

21. The apparatus of claim 20 wherein the Z-controller decreases a height of the Y-shaped nozzle relative to the pressure sensor die until it receives a signal from the pressure sensor that a specific backpressure has been reached, then the Z-controller substantially maintains the height of the Y-shaped nozzle relative to the pressure sensor die.

22. A method of testing a pressure sensor die, the method comprising:
directing a flow of a fluid at a surface of a frame of the pressure sensor die, where the fluid is provided by a nozzle;
measuring a resulting first backpressure in the nozzle;
adjusting a height of the nozzle relative the surface of the frame of the pressure sensor die based on the measured resulting first backpressure until a target backpressure is reached;
directing the flow of the fluid to a membrane of the pressure sensor die; and
measuring a resulting second backpressure.

23. The method of claim 22 further comprising using the second backpressure to estimate a deflection of the membrane.

24. The method of claim 22 further comprising:
adjusting a height of the nozzle relative the surface of the membrane pressure sensor die based on the measured resulting second backpressure until the target backpressure is reached again.

25. The method of claim 22 wherein the flow of the fluid is directed using a Y-shaped nozzle, wherein the fluid is received at a first branch of the Y, the resulting backpressure is measured at a second branch of the Y, and the fluid is directed using a third branch of the Y.
